(19) United States
(12) Patent Application Publication
(10) Pub. No.: US 2017/0249399 A1
(43) Pub. Date: Aug. 31, 2017

(54) Method And Apparatus For Displaying Recommendation Result

(71) Applicant: Baidu Online Network Technology (Beijing) Co., Ltd, Beijing (CN)

(72) Inventors: Yuzhou HU, Beijing (CN); Zhen LEI, Beijing (CN); Xiaobo LIU, Beijing (CN); Peng ZHAO, Beijing (CN); Haifeng WANG, Beijing (CN); Ying LI, Beijing (CN)

(21) Appl. No.: 14/392,249

(22) PCT Filed: Dec. 15, 2014
(86) PCT No.: PCT/CN2014/093872

§ 371 Date: May 10, 2017

(30) Foreign Application Priority Data
Jul. 16, 2014 (CN) 201410339478.7

(51) Int. Cl. G06F 17/30

(52) U.S. Cl. CPC G06F 17/30991; G06F 17/30958; G06F 17/30867; G06F 17/30967

(57) ABSTRACT

A method for displaying a recommendation result and an apparatus for displaying a recommendation result are provided. The method includes: receiving a query; obtaining a mapping knowledge graph containing the query; and displaying the mapping knowledge graph in a preset recommendation area of a search result page. The method can display more sufficient and accurate recommended content, so as to improve the user experience.

### CROSS-REFERENCE TO RELATED APPLICATION

This application is a U.S. national phase application of International Application No. PCT/CN2014/093872, filed on Dec. 15, 2014, which claims priority to Chinese Patent Application Serial No. 201410339478.7, titled “Method and Apparatus for Displaying Recommendation Result” filed by Baidu Online Network Technology (Beijing) Co., Ltd on Jul. 16, 2014.

### FIELD

The present disclosure generally relates to the field of communication technology, and more particularly to a method for displaying a recommendation result and an apparatus for displaying a recommendation result.

### BACKGROUND

Currently, a search result page is usually divided into left and right parts. The left part is configured to display a specified result out of an objective-clarified search behavior to satisfy a search requirement. For example, a search result presenting a clock is displayed under a search for “Beijing time”. The right part is configured to stimulate more requirements, including various forms, like giving a relevant recommendation, a relevant ranking list and a relevant event, but the primary form to display is a recommendation card. For example, the right part includes a card whose line and row may be set and adjusted, in order to display relevant recommendations via the card.

However, there is a problem that the content contained in the recommendation card displayed in the right part is not sufficient or accurate enough.

### SUMMARY

The present disclosure seeks to solve at least one of the above technical problems in the related art to at least some extent.

Accordingly, an objective of the present disclosure is to provide a method for displaying a recommendation result. The method can display more sufficient and accurate recommended content, so as to improve the user experience.

Another objective of the present disclosure is to provide an apparatus for displaying a recommendation result.

In order to achieve above objectives, embodiments of a first aspect of the present disclosure provide a method for displaying a recommendation result. The method includes: receiving a query; obtaining a mapping knowledge graph containing the query; and displaying the mapping knowledge graph in a preset recommendation area of a search result page.

With the method according to the embodiments of the first aspect of the present disclosure, the mapping knowledge graph containing the query is displayed in the recommendation area, and the mapping knowledge graph with good visuality includes sufficient and accurate information, such that the user may be provided with an abundant, accurate and sophisticated recommendation result, so as to improve the user experience.

In order to achieve above objectives, embodiments of a second aspect of the present disclosure provide an apparatus for displaying a recommendation result. The apparatus includes: a processor; a memory configured to store an instruction executable by the processor; wherein the processor is configured to: receive a query; obtain a mapping knowledge graph containing the query; and display the mapping knowledge graph in a preset recommendation area of a search result page.

With the apparatus according to the embodiments of the first aspect of the present disclosure, the mapping knowledge graph containing the query is displayed in the recommendation area, and the mapping knowledge graph with good visuality includes sufficient and accurate information, such that the user may be provided with an abundant, accurate and sophisticated recommendation result, so as to improve the user experience.

In order to achieve above objectives, embodiments of a third aspect of the present disclosure provide a non-transitory computer-readable storage medium having stored therein instructions that, when executed by a processor of an electronic device, causes the electronic device to perform a method for displaying a recommendation result, the method including: receiving a query; obtaining a mapping knowledge graph containing the query; and displaying the mapping knowledge graph in a preset recommendation area of a search result page.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

These and/or additional aspects and advantages of embodiments of the present disclosure will become apparent and more readily appreciated from the following descriptions made with reference to the drawings, in which:

FIG. 1 is a flow chart of a method for displaying a recommendation result according to an embodiment of the present disclosure.

FIG. 2 is a schematic diagram of displaying a search result page of a mapping knowledge graph according to an embodiment of the present disclosure.

FIG. 3 is a flow chart of a method for displaying a recommendation result according to another embodiment of the present disclosure.

FIG. 4 is a schematic diagram after clicking a central node of a mapping knowledge graph according to an embodiment of the present disclosure.

FIG. 5 is a schematic diagram of restarting a search after clicking a line according to an embodiment of the present disclosure.

FIG. 6 is a schematic diagram of displaying relationship between nodes when selecting a line according to an embodiment of the present disclosure.

FIG. 7 is a block diagram of an apparatus for displaying a recommendation result according to another embodiment of the present disclosure.

FIG. 8 is a block diagram of an apparatus for displaying a recommendation result according to another embodiment of the present disclosure.

### DETAILED DESCRIPTION

Embodiments of the present disclosure will be described in detail and examples of the embodiments will be illustrated in the drawings, in which same or similar reference numerals are used to indicate same or similar members or members with same or similar functions. The embodiments described herein with reference to drawings are explanatory, which are used to illustrate the present disclosure, but shall not be construed to limit the present disclosure. In contrast, the embodiments of the present disclosure may include alternatives, modifications and equivalents within the spirit and scope of the appended claims.

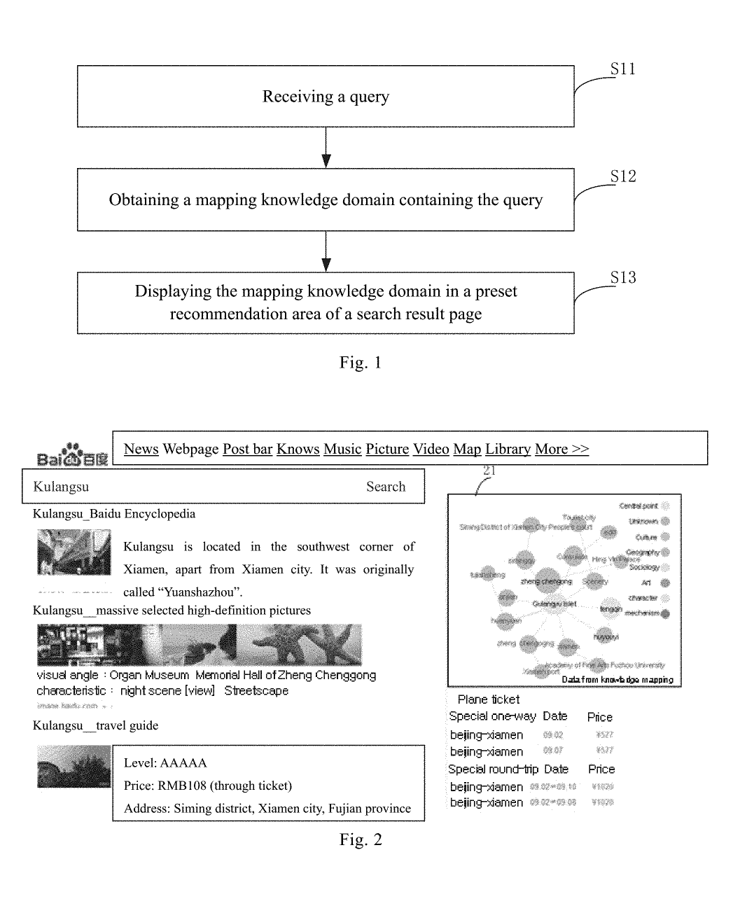

FIG. 1 is a flow chart of a method for displaying a recommendation result according to an embodiment of the present disclosure. The method includes the following steps.

In step 11, a query is received.

The query is used to describe an entity that is a distinguishable object in the objective world. For example, the query is “Kulangsu”.

In step 12, a mapping knowledge graph containing the query is obtained.

The mapping knowledge graph is also called a scientific knowledge graph, referred to as knowledge domain visualization or a graph of knowledge domain mapping in the books and information field, and involves a series of various graphs for showing the knowledge development process and the structural relationship. The mapping knowledge graph is configured to describe knowledge resources and carriers thereof, and to mine, analyze, establish, draw and display knowledge and the interrelation thereof by a visualization technique.

Specifically, the mapping knowledge graph is a modern theory for multi-disciplinary integration by combining metrological citation analysis and co-occurrence analysis with the theories and methods of disciplines (such as mathematics, graphics, information visualization technology and informatics), and vividly displaying the core structure, development history, frontier domains, and overall knowledge structures by means of visual graphs. The mapping knowledge graph reflects a complicated knowledge domain by data mining, information processing, knowledge measurement and graphing, reveals the dynamic development rules of the knowledge domain, and provides practical and valuable reference for discipline research.

In an embodiment of the present disclosure, the mapping knowledge graph consists of nodes and a line for connecting two nodes, each node corresponding to an entity. If there is a relationship between entities corresponding to two nodes, the two nodes may be connected together by the line.

It shall be understood that the mapping knowledge graph is not limited to the above form composed by nodes and lines, but may include other forms. Any variations of the mapping knowledge graph fall into the protection scope of the present disclosure.

A server may establish a mapping knowledge graph with an entity in advance according to the above technology necessary for creating the mapping knowledge graph, and then a query is sent to the server after a search engine receives the query. The server may find out a corresponding mapping knowledge graph containing the entity described by the query from the pre-established mapping knowledge graphs.

Further, the server may send a mapping knowledge graph with the entity described by the query as a central node to the search engine for display.

In step 13, the mapping knowledge graph is displayed in a preset recommendation area of a search result page.

The preset recommendation area may be located at the left side or right side of the search result page. With the right side as the example, as shown in FIG. 2, when the query is “Kulangsu”, a mapping knowledge graph 21 with “Kulangsu” as the central node may be displayed at the right side of the search result page.

In the embodiment of the present disclosure, the mapping knowledge graph containing the query is displayed in the recommendation area, and the mapping knowledge graph with good visuality includes sufficient and accurate information, such that the user may be provided with an abundant, accurate and sophisticated recommendation result, so as to improve the user experience.

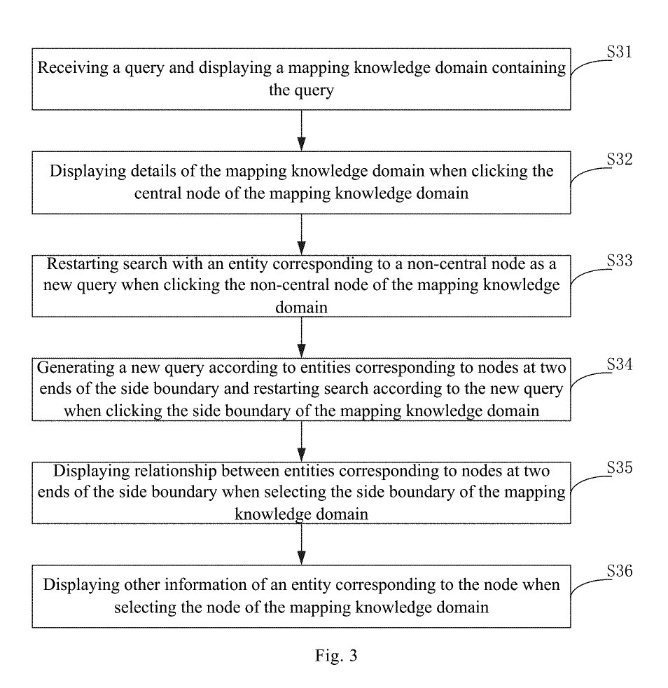

FIG. 3 is a flow chart of a method for displaying a recommendation result according to another embodiment of the present disclosure. The method includes the following steps.

In step 31, a query is received, and a mapping knowledge graph containing the query is displayed according to the query.

The specific implementation process may refer to the embodiment shown in FIG. 1. A recommendation result may be displayed as FIG. 2 after processing of FIG. 1.

The nodes and lines of the mapping knowledge graph may be clicked.

In step 32, details of the mapping knowledge graph are displayed when the central node of the mapping knowledge graph is clicked.

Since the search result page has limited space, the mapping knowledge graph displayed on the search result page is a small simplified graph, as shown in FIG. 2.

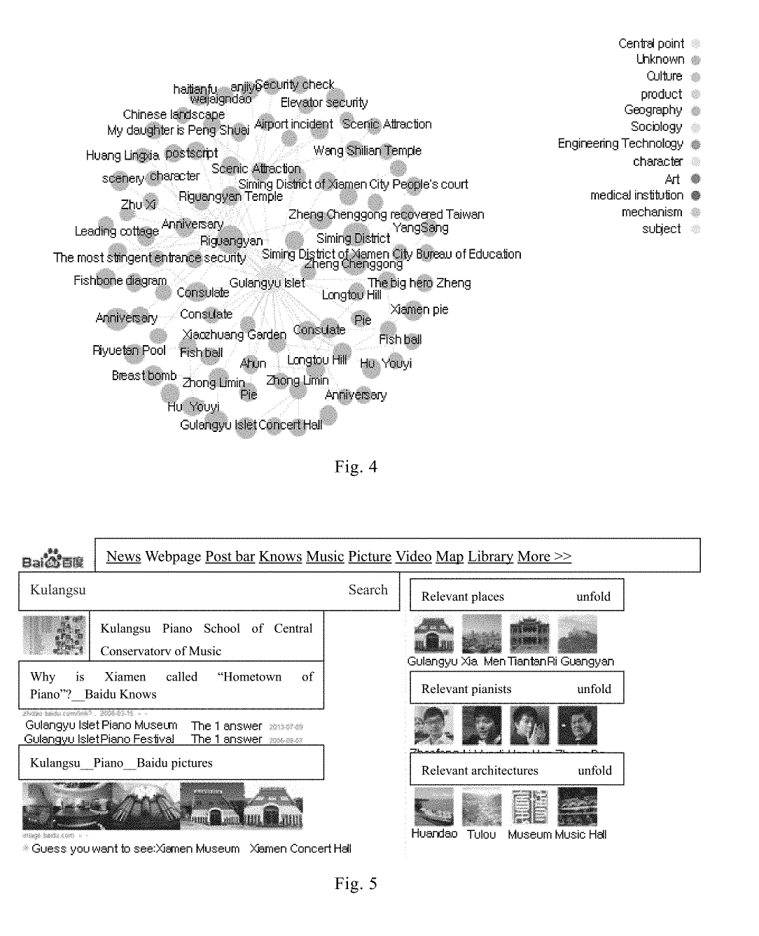

Referring to FIG. 4, a big graph may be displayed after the central node is clicked, so as to check the details of the mapping knowledge graph. The respective areas occupied by the big and small graphs may be preset, the area of the big graph being several times greater than that of the small graph.

Alternatively, the nodes of the mapping knowledge graph may include different types, and different types of nodes are identified by different colors. For example, the types may include “culture,” “products” and “geography”, identified by yellow, purple and blue respectively.

In step 33, search is restarted with an entity corresponding to a non-central node as a new query when the non-central node of the mapping knowledge graph is clicked.

For example, when a node corresponding to “Sunlight Rock” is clicked, “Sunlight Rock” is input in a search bar automatically, to launch the search for “Sunlight Rock”.

In step 34, a new query according to entities corresponding to nodes at two ends of the line and the search is restarted according to the new query, when the line of the mapping knowledge graph is clicked.

Specifically, the step of generating the new query according to entities corresponding to nodes at two ends of the line includes: forming the new query from the entities corresponding to nodes at two ends of the line.

For example, when a line between a node corresponding to “Kulangsu” and a node corresponding to “a piano” is clicked, a new query “Kulangsu piano” may be input in the search bar automatically, and a new search is launched regarding the new query.

In step 35, a relationship between the entities corresponding to nodes at two ends of the line is displayed when the line of the mapping knowledge graph is selected.

The step of selecting the line of the mapping knowledge graph includes: hovering a cursor produced by a mouse or a keyboard key over the line; or touching the line by using a touch object.

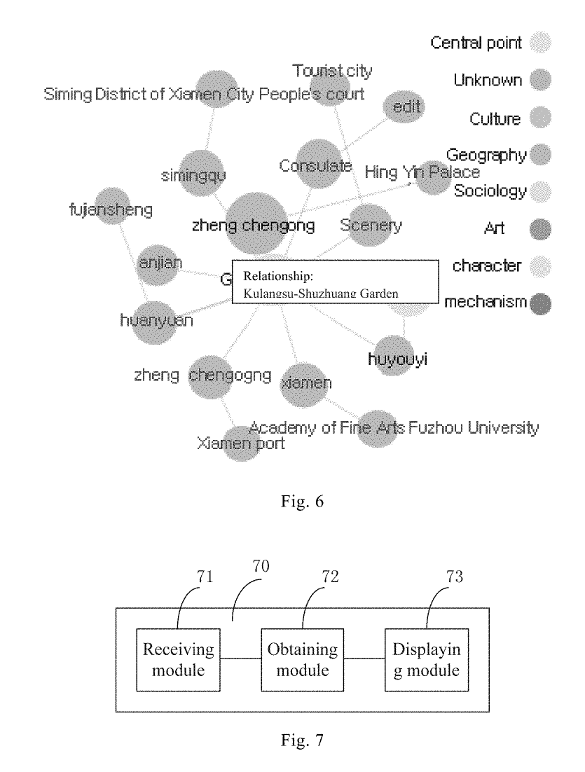

Supposing that a selection instruction is generated by hovering a cursor produced by a mouse over the line, referring to FIG. 6, the relationship between “Kulangsu” and “Piano Museum” may be displayed when the cursor produced by the mouse hovers over the line between a node corresponding to “Kulangsu” and a node corresponding to “Piano Museum”. It shall be understood that the relationship in FIG. 6 is configured as an example for brief description, and more description about the relationship may be given in an actual implementation.

In step 36, other information of an entity corresponding to the node is displayed when the node of the mapping knowledge graph is selected.

The step of selecting the node of the mapping knowledge graph includes: hovering a cursor produced by a mouse or a keyboard key over the node; or touching the node by using a touch object.

Supposing that a selection instruction is generated by hovering a cursor produced by a mouse over the node, detailed information of the entity corresponding to the node may be displayed in a hover box or a drop-down subordinate card or in another form.

It shall be understood that the steps 32 to 36 have no sequence-restricted relationship among them, one or more of which may be implemented.

Further, the mapping knowledge graph may have a dynamic effect, and may include but not be limited to a force-directed graph, a reversible word cloud, etc.

By displaying the mapping knowledge graph in the recommendation area, the embodiment may have many advantageous effects, including but not limited to the following effects.

(1) Clear recommendation reasons: any node corresponding to the entity or line in the graph may be clicked to launch the search, apart from that the user hovers the mouse over the node or line to view more content displayed in the hover box or the subordinate card. When the node is clicked, the entity corresponding to the node is transformed into a query for launching the search; when the line is clicked, a query corresponding to the boundary relation is constructed automatically. In such a way, the explication of the recommendation reasons is to guide and satisfy the search, and thus the user may explicitly acquire specific contents of the nodes and lines of the graph.

(2) Comprehensive knowledge coverage: the massive data in the knowledge base covers extensive fields, and appropriate and appealing knowledge points of recommendations are obtained by improved mining and reasoning computational algorithm. The data of the mapping knowledge graph almost covers all the knowledge domains; for a query, all the relevant entities and relationships may be computed by the mapping knowledge graph and displayed on the page together. For example, for a query “Li Yanhong”, the result may include notable events related to him (such as “Business War in Silicon Valley,” “China IT Leadership Summit in 2011,” “Project Lightning,” etc.), evaluation on him (like “the King of Search: Li Yanhong”), and technologies (“hyperlink analysis technology,” “box computing,” etc.), besides relevant figures (“Ma Dongmin,” “Xu Yong,” etc.), the enterprise concerned (i.e. “Baidu”). That is, the result covers various fields and display comprehensive and preferential knowledge related to the query horizontally and vertically. Of course, the user may acquire much knowledge by reading a lot of targeted page articles via the search engine, but the process is both time and effort consuming. In this embodiment, the interesting strong ties may be visually displayed in a single graph through various algorithms combined, such as the weighing algorithm and the evolutionary algorithm, such that the user may conveniently get a comprehensive understanding of the background knowledge according to his interest.

(3) Revolution of the recommendation algorithm: it is no longer limited to data such as the user hit log, query co-occurrence data. Instead, any page content related to entities corresponding to the query may be mined from the entire pages directly, then the entities and relationships therein are analyzed, and finally, a series of mapping and reasoning are conducted with the existing data and service of the mapping knowledge graph, so as to display a mapping knowledge graph with the entity corresponding to the query as the central node. In conclusion, the algorithm involved herein is query page entity, and the recommendations obtained thereby are more time-efficient, strongly related and knowledgeable.

(4) Vivid and simple interaction in a novel and interesting style: the graph (or another similar style capable of displaying the entities and the relationship between the entities, different from the recommendation card) is introduced into and displayed in the search product for the first time. The mapping knowledge graph with the query as the center is displayed in the form of visual nodes (the entities) and lines (the relationship between the entities), along with classification, figures and other simple instructions, to attract the user's attention immediately and provide abundant valuable information. A three-dimensional spherical surface or other designs may be adopted later.

(5) Mining and displaying multilevel relationship: the product may mine and display a multilevel relationship beside the relationship between the recommendation and the query, including the relationship between the recommendations. The multilevel relationship may have an unexpected effect that inspires the user to explore and increases the gain of knowledge acquisition, so as to promote the next click.

(6) Some strongly related queries that contain curiosity-arousing knowledge points but do not directly trig a common search requirement in the user's mind may be visually displayed and directly clicked, such as “Kulangsu, Zheng Chenggong” and “jasmine, Chanel No. 5 perfume”.

(7) Unity of commercial value and user requirement: the business flow was mainly initiated by the left side, but now the user may be further guide in a natural and smooth way to click the search with potential commercial value in the right side. For example, if the user searches for “Xuyi Crawfish”, a specific trade name may appear in the right side, and then the user may click the trade name to launch a new search for details. For another example, for a query “jamine”, “Chanel No. 5 perfume” may appear; the perfume is clicked for a new search, and a Chanel advertisement may appear in the right side.

(8) Contribution to various specific application scenarios (such as marketing analysis and public opinion analysis): online concerns about certain matters may be learned from the graph effect of some specific queries, to help formulate follow-up development plans.

In conclusion, in this embodiment, it is possible to display more abundant, accurate and targeted information and to inspire new click behaviors by displaying the mapping knowledge graph; it is possible to raise the click rate per capita of the search result page by launching the new search, which may realize the increase of search traffic when the number of netizens has reached a certain bottleneck.

FIG. 7 is a block diagram of an apparatus for displaying a recommendation result according to another embodiment of the present disclosure. The apparatus 70 includes: a receiving module 71, an obtaining module 72 and a displaying module 73.

The receiving module 71 is configured to receive a query.

The query is used to describe an entity that is a distinguishable object in the objective world. For example, the query is “Kulangsu”.

The obtaining module 72 is configured to obtain a mapping knowledge graph containing the query.

The mapping knowledge graph is also called a scientific knowledge graph, referred to as knowledge domain visualization or a graph of knowledge domain mapping in the books and information field, and involves a series of various graphs for showing the knowledge development process and the structural relationship. The mapping knowledge graph is configured to describe knowledge resources and carriers thereof, and to mine, analyze, establish, draw and display knowledge and the interrelation thereof by a visualization technique.

Specifically, the mapping knowledge graph is a modern theory for multi-disciplinary integration by combining metrological citation analysis and co-occurrence analysis with the theories and methods of disciplines (such as mathematics, graphics, information visualization technology and informatics), and vividly displaying the core structure, development history, frontier domains, and overall knowledge structures by means of visual graphs. The mapping knowledge graph reflects a complicated knowledge domain by data mining, information processing, knowledge measurement and graphing, reveals the dynamic development rules of the knowledge domain, and provides practical and valuable reference for discipline research.

The mapping knowledge graph consists of nodes and a line for connecting two nodes, each node corresponding to an entity. If there is a relationship between entities corresponding to two nodes, the two nodes may be connected together by the line.

A server may establish a mapping knowledge graph with an entity in advance according to the above technology necessary for creating the mapping knowledge graph, and then a query is sent to the server after a search engine receives the query. The server may find out a corresponding mapping knowledge graph containing the entity described by the query from the pre-established mapping knowledge graphs.

Further, the server may send a mapping knowledge graph with the entity described by the query as a central node to the search engine for display.

The displaying module 73 is configured to display the mapping knowledge graph in a preset recommendation area of a search result page.

The preset recommendation area may be located at the left side or right side of the search result page. With the right side as the example, as shown in FIG. 2, when the query is “Kulangsu”, a mapping knowledge graph 21 with “Kulangsu” as the central node may be displayed at the right side of the search result page.

In an embodiment, the mapping knowledge graph is composed of nodes and a line connecting two nodes, and an entity corresponding to a central node of the mapping knowledge graph is the query.

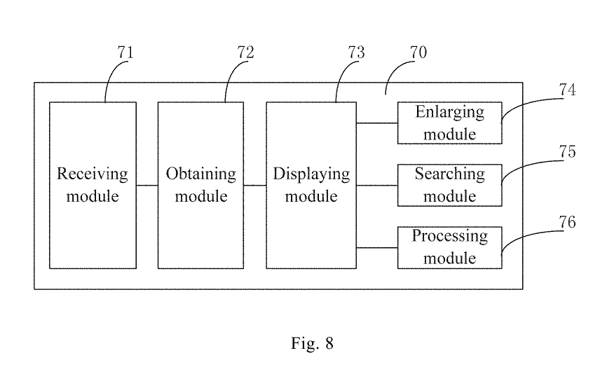

Referring to FIG. 8, the apparatus 70 further includes an enlarging module 74 configured to display details of the mapping knowledge graph when the central node of the mapping knowledge graph is clicked.

Since the search result page has limited space, the mapping knowledge graph displayed on the search result page is a small simplified graph, as shown in FIG. 2.

Referring to FIG. 4, a big graph may be displayed after the central node is clicked, so as to check the details of the mapping knowledge graph. The respective areas occupied by the big and small graphs may be preset, the area of the big graph being several times greater than that of the small graph.

Alternatively, the mapping knowledge graph is composed of nodes and a line connecting two nodes. The nodes of the mapping knowledge graph may include different types, and different types of nodes are identified by different colors. For example, the types may include “culture,” “products” and “geography”, identified by yellow, purple and blue respectively.

In an embodiment, referring to FIG. 8, the apparatus 70 further includes a searching module 75 configured to restart search with an entity corresponding to a non-central node as a new query when the non-central node of the mapping knowledge graph is clicked.

For example, when a node corresponding to “Sunlight Rock” is clicked, “Sunlight Rock” is input in a search bar automatically, to launch the search for “Sunlight Rock”.

In an embodiment, referring to FIG. 8, the apparatus 70 further includes a processing module 76 configured to: generate a new query according to entities corresponding to nodes at two ends of the line and restart search according to the new query when the line of the mapping knowledge graph is clicked; or display relationship between entities corresponding to nodes at two ends of the line when the line of the mapping knowledge graph is selected; or display other information of an entity corresponding to the node when the node of the mapping knowledge graph is selected.

In an embodiment, the processing module 76 is specifically configured to form the new query from the entities corresponding to nodes at two ends of the line.

For example, when a line between a node corresponding to “Kulangsu” and a node corresponding to “a piano” is clicked, a new query “Kulangsu piano” may be input in the search bar automatically, and a new search is launched regarding the new query.

In an embodiment, the processing module 76 is specifically configured to hover a cursor produced by a mouse or a keyboard key over the line or the node; or touch the line or the node by using a touch object.

Supposing that a selection instruction is generated by hovering a cursor produced by a mouse over the line, referring to FIG. 6, the relationship between “Kulangsu” and “Piano Museum” may be displayed when the cursor produced by the mouse hovers over the line between a node corresponding to “Kulangsu” and a node corresponding to “Piano Museum”. It shall be understood that the relationship in FIG. 6 is configured as an example for brief description, and more description about the relationship may be given in an actual implementation.

Supposing that a selection instruction is generated by hovering a cursor produced by a mouse over the node, detailed information of the entity corresponding to the node may be displayed in a hover box or a drop-down subordinate card or in another form.

In an embodiment, the displaying module 73 is specifically configured to display the mapping knowledge graph dynamically, including but not limited to a force-directed graph, a reversible word cloud, etc.

In this embodiment, the mapping knowledge graph containing the query is displayed in the recommendation area, and the mapping knowledge graph with good visuality includes sufficient and accurate information, such that the user may be provided with an abundant, accurate and sophisticated recommendation result, so as to improve the user experience.

Embodiments of the present disclosure further provide an electronic device. The device includes: one or more processors; a memory; and one or more programs stored in the memory and configured to conduct the following operations when executed by the one or more processors: receiving a query, obtaining a mapping knowledge graph containing the query, and displaying the mapping knowledge graph in a preset recommendation area of a search result page.

Embodiments of the present disclosure further provide a non-transitory computer-readable storage medium having stored therein instructions that, when executed by a processor of an electronic device, causes the electronic device to perform a method for displaying a recommendation result according to the above embodiments.

It shall be noted that terms such as “first” and “second” are used herein for purposes of description and are not intended to indicate or imply relative importance. Furthermore, in the description of the present disclosure, “a plurality of” means two or more, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, not necessarily in the sequence shown or discussed here, but probably including the almost same or reverse sequence of the involved functions, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The computer readable storage medium may be, but is not limited to, read-only memories, magnetic disks, or optical disks.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments are explanatory and cannot be construed to limit the present disclosure, and changes, modifications, alternatives and variations can be made in the embodiments without departing from spirit, principles and scope of the present disclosure.

What is claimed is:

1. A method for displaying a recommendation result, comprising:
receiving a query;
obtaining a mapping knowledge graph containing the query; and
displaying the mapping knowledge graph in a preset recommendation area of a search result page.

2. The method according to claim 1, wherein the mapping knowledge graph is composed of nodes and a line connecting two nodes, and an entity corresponding to a central node of the mapping knowledge graph is the query.

3. The method according to claim 2, further comprising:
displaying details of the mapping knowledge graph when clicking the central node of the mapping knowledge graph.

4. The method according to claim 2, further comprising:
restarting search with an entity corresponding to a non-central node as a new query when clicking the non-central node of the mapping knowledge graph.

5. The method according to claim 1, wherein the mapping knowledge graph is composed of nodes and a line connecting two nodes, and the method further comprises:
generating a new query according to entities corresponding to nodes at two ends of the line and restarting search according to the new query when clicking the line of the mapping knowledge graph; or
displaying relationship between entities corresponding to nodes at two ends of the line when selecting the line of the mapping knowledge graph; or
displaying other information of an entity corresponding to the node when selecting the node of the mapping knowledge graph.

6. The method according to claim 5, wherein generating a new query according to entities corresponding to nodes at two ends of the line comprises:
forming the new query from the entities corresponding to nodes at two ends of the line.

7. The method according to claim 5, wherein selecting the line or the node of the mapping knowledge graph comprises:
hovering a cursor produced by a mouse or a keyboard key over the line or the node; or touching the line or the node by using a touch object.

8. The method according to claim 1, wherein the mapping knowledge graph is composed of nodes and a line connecting two nodes, and the nodes of the mapping knowledge graph have different types, and the nodes of different types are identified by different colors.

9. The method according to claim 1, wherein displaying the mapping knowledge graph comprises: displaying the mapping knowledge graph dynamically.

10. An apparatus for displaying a recommendation result, comprising:
a processor;
a memory configured to store an instruction executable by the processor;
wherein the processor is configured to:
receive a query;
obtain a mapping knowledge graph containing the query; and
display the mapping knowledge graph in a preset recommendation area of a search result page.

11. The apparatus according to claim 10, wherein the mapping knowledge graph is composed of nodes and a line connecting two nodes, and an entity corresponding to a central node of the mapping knowledge graph is the query.

12. The apparatus according to claim 11, wherein the processor is further configured to:
display details of the mapping knowledge graph when the central node of the mapping knowledge graph is clicked.

13. The apparatus according to claim 11, wherein the processor is further configured to:
restart search with an entity corresponding to a non-central node as a new query when the non-central node of the mapping knowledge graph is clicked.

14. The apparatus according to claim 10, wherein the mapping knowledge graph is composed of nodes and a line connecting two nodes, and the processor is further configured to:
generate a new query according to entities corresponding to nodes at two ends of the line and restart search according to the new query when the line of the mapping knowledge graph is clicked; or
display relationship between entities corresponding to nodes at two ends of the line when the line of the mapping knowledge graph is selected; or
display other information of an entity corresponding to the node when the node of the mapping knowledge graph is selected.

15. The apparatus according to claim 14, wherein the processor is specifically configured to form the new query from the entities corresponding to nodes at two ends of the line.

16. The apparatus according to claim 14, wherein the processor is specifically configured to:
hover a cursor produced by a mouse or a keyboard key over the line or the node; or touch the line or the node by using a touch object.

17. The apparatus according to claim 10, wherein the mapping knowledge graph is composed of nodes and a line connecting two nodes, and the nodes of the mapping knowledge graph have different types, and the nodes of different types are identified by different colors.

18. The apparatus according to claim 10, wherein the processor is specifically configured to display the mapping knowledge graph dynamically.

19. (canceled)

20. A non-transitory computer-readable storage medium having stored therein instructions that, when executed by a processor of an electronic device, causes the electronic device to perform a method for displaying a recommendation result, the method comprising
receiving a query;
obtaining a mapping knowledge graph containing the query; and
displaying the mapping knowledge graph in a preset recommendation area of a search result page.
